(19) United States
(12) Patent Application Publication
(10) Pub. No.: US 2009/0241051 A1
(43) Pub. Date: Sep. 24, 2009

(54) MONITOR CAPABLE OF DISPLAYING CERTAIN EVENT

(76) Inventors: Chen-Pang LI, Hsichih (TW); Chao-Wei Huang, Hsichih (TW)

Correspondence Address: SINORICA, LLC, 2275 Research Blvd., Suite 500, ROCKVILLE, MD, 20850, US

(21) Appl. No.: 12/196,660

(22) Filed: Aug. 22, 2008

(30) Foreign Application Priority Data
Mar. 19, 2008 (TW) 097109733

(51) Int. Cl. G06F 3/048

(52) U.S. Cl. 715/771

(57) ABSTRACT

A monitor capable of displaying certain event and method thereof are disclosed. The method comprises the following steps. First, the microprocessor of the monitor is used to receive the event code, and the microprocessor of the monitor is then used to determine whether the event code is stored in a storage unit in advance. The OSD function is enabled and the words corresponding to the event code is displayed on the monitor when the microprocessor of the monitor determines that the event code is stored in the storage unit in advance. Therefore, users can monitor the occurred events from different signal sources simultaneously while watching TV.

### BACKGROUND OF THE INVENTION

1. Field of the Invention

The present invention relates to a monitor, particularly to a monitor which allows users to monitor the occurred events from different signal sources simultaneously.

2. Description of the Related Art

Currently, ordinary monitors, such as TV and Flat panel display, most of them have plural I/O interfaces to connect different electronic apparatus. As shown in FIG. 1, the monitor 101 has plural input interfaces to provide more convenient choices to user. For example, a HDMI interface for connecting DVD player, a VGA interface for connecting computer 103, a USB interface for connecting camera 104. With various settings of interfaces, the monitor 101 can receive various image and sound signals or data format, and provide users with choices to switch various signals from signal sources freely. The user can decide which input signal to be processed by microprocessor, and the processed signal contents are displayed on the monitor to generate the screen. However, at this time, the signals at other interfaces are still transmitted to the monitor but not processed by the microprocessor. Thus, if the input signals are preset to be recognized by the microprocessor simultaneously, then these signals can be input simultaneously. For instance, the signal transmitted from remote controller 105 for turning on OSD function of TV.

However, the monitors connected with many signal sources can only select one of signal sources for one time to process, and display the processed image on the monitor, the users can not be aware of the events from other signal sources. If users want to monitor more than one signal sources simultaneously, they can only switch over signal sources frequently so as to see the events from other signal sources. This design is quite inconvenient to users.

Similar problem also exists in monitors which connect to only one signal source. Today, many application programs support full-screen display. When users want to display a program on the screen clearly, they often set the application programs to display in full-screen mode, ex: watching movies or report presentation. However, at that time, other application programs in the system are still executing, for example, MSN or receiving E-mails, these events are still happening, and users might also want to monitor these application programs to see whether the certain event occurs, and switch full screen on time to process the event. For the current designs, if users want to monitor other application programs except the application program executed in full-screen mode, ex: whether received MSN messages or the latest E-mails, all they can do is to switch over windows frequently. This is not user-friendly at all.

In prior art, to solve the problem, some application programs not only can be set to display in full-screen mode, but cancel the full-screen mode when other application program is executing certain action. For instance, when the web browser opens a new web page or the MSN receives a message, the full-screen mode of watching video will be cancelled automatically. Thus, users may see other events from other windows. This manner allows users to monitor and manage the message on time. However, this manner will force the full-screen mode to close, and the user has no choice and the events can't be omitted temporarily, thereby brings unnecessary trouble to users.

### SUMMARY OF THE INVENTION

Therefore, the objective of this present invention is to provide a method of utilizing the OSD (On Screen Display) function which originally exists in the monitor to actively remind users that certain event occurs. The monitor is connected with one or plural signal sources, which can be a computer, DVD Player, or a camera. The method allows users to monitor the occurrence of certain events without affecting the image displayed by currently monitored application programs or signal sources while the monitor is set in full-screen mode or inputted plural signal sources. Thus, users may freely select to close the full-screen mode or switch signal sources to deal with the events.

The method capable of displaying an occurred event comprises the steps of: (A) Receiving event code which is generated by any of signal source according to the occurred event; (B) When a microprocessor in the monitor with OSD function receives the event code, the microprocessor determines whether the event code is stored in a storage unit in advance; (C) enabling the OSD function and displaying the words corresponding to the event code on the monitor if the event code is stored in the storage unit in advance.

Preferably, the method of the present invention further includes a manner of generating event code for a microprocessor of the signal source. The microprocessor of the signal source can monitor every application programs to check whether a certain event occurs, and generate an event code according to the certain event, or actively transmits the event code to the monitor when the certain event occurs in the application programs.

Besides, the present invention further provides a monitor with OSD function for realizing the method of the present invention. The monitor comprises a display unit, an input unit, a microprocessor with OSD function, and a storage unit. The display unit is for outputting image signals, and the input unit is connected to the microprocessor and connected the input interface of a signal source, for inputting image signal and event code of every signal source to the microprocessor. The microprocessor with OSD function is connected to the input unit, and controls the activation or close of OSD function, and displays the corresponding words stored in the storage unit onto the monitor by OSD according to the inputted event code.

### BRIEF DESCRIPTION OF THE DRAWINGS

The subject matter regarded as the invention is particularly pointed out and distinctly claimed in the concluding portion of the specification. The invention, both as to apparatus and method of operation, together with features and advantages thereof may best be understood by reference to the following detailed description with the accompanying drawings in which:

FIG. 1 is a schematic chart of a monitor connected with a plurality of signal sources;

FIG. 2 is a flow chart of the method of displaying event messages in the embodiment of the present invention;

FIG. 3 is an interior block diagram of the monitor with OSD function in the embodiment of the present invention;

FIG. 4 is a detail block diagram of the system of displaying event on the monitor of the embodiment of the present invention; and

FIG. 5 is schematic chart of an event message displayed on the monitor by the OSD of the embodiment of the present invention.

### DETAILED DESCRIPTION OF THE PREFERRED EMBODIMENTS

While the specifications describe at least one embodiment of the invention considered best modes of practicing the invention, it should be understood that the invention can be implemented in many ways and is not limited to the particular examples described below or to the particular manner in which any features of such examples are implemented.

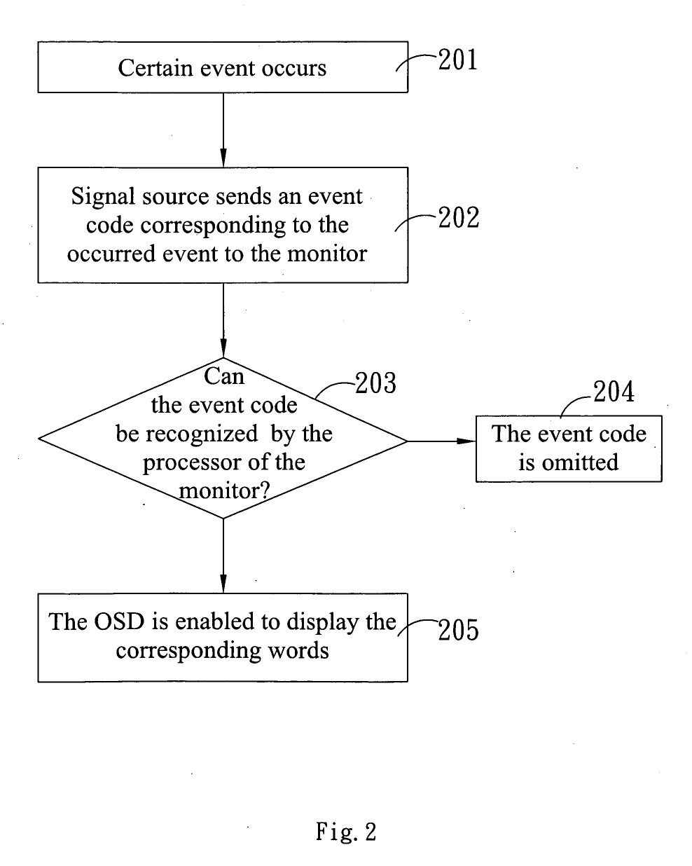

FIG. 2 illustrates a preferred embodiment of the method of the present invention. The method comprises the following steps. In step 201, when a certain event occurs in any signal source, for example, a computer receives a MSN message, and then the signal source sends an event code corresponding to the occurred event to the monitor in step 202. When the monitor receives the event code, the event code is determined whether it can be recognized by the processor of the monitor in step 203. If the data can't be recognized, the data is omitted in step 204; if the data can be recognized, the OSD is enabled to display the words corresponding to the event code in step 205.

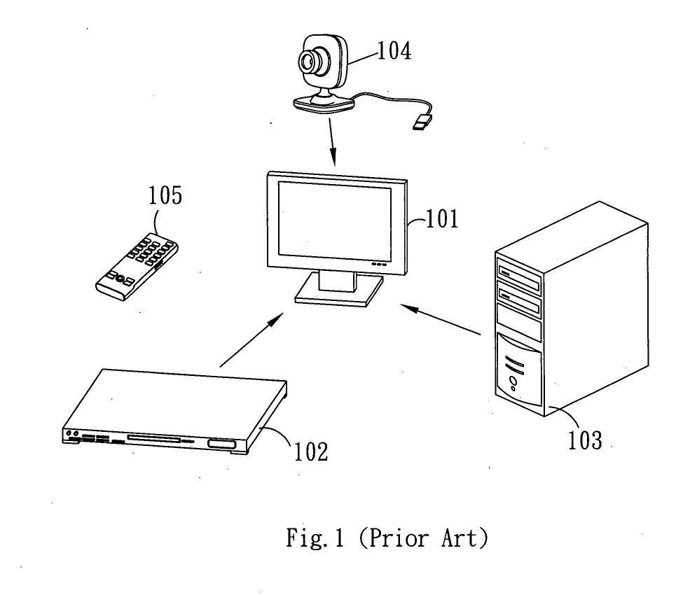

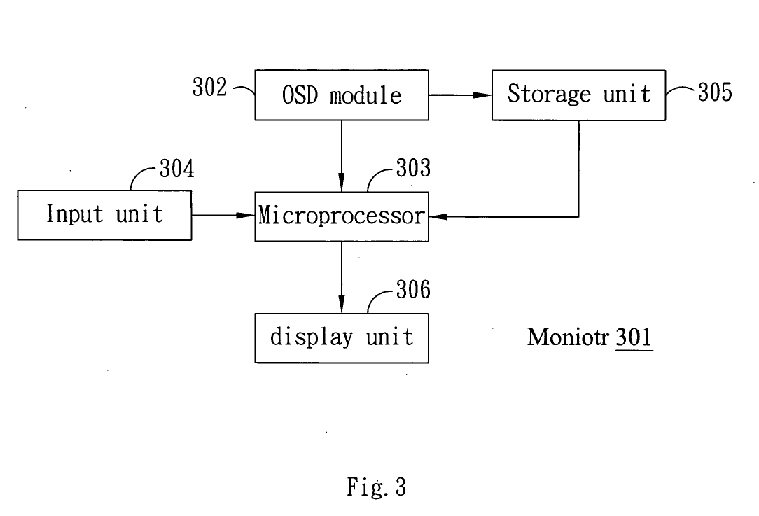

FIG. 3 illustrates an embodiment of monitor of the present invention. In this embodiment, the monitor 301 is a TV with OSD function or a display apparatus, such as conventional CRT TV, LCD TV, Plasma TV, LCD or PDP. There are mainly two manner of enabling OSD function of the monitor: one is to overlap and combine the signals of exterior OSD module 302 and microprocessor 303; the other is to equip OSD module 302 into microprocessor 303, and directly overlap OSD information in Video Buffer. In both realization manners, when receiving a signal from input unit 304, microprocessor 303 of the monitor will determine whether the signal is an enabling signal for enabling OSD function. If yes, the OSD module 302 is enabled, and the microprocessor 303 searches the symbol generator stored in storage unit 305 of the monitor, and outputs the search result to display unit 306. Preferably, the enabling signal can be a user operation command transmitted from remote controller 105 shown in FIG. 1, or an event code transmitted from other input interface.

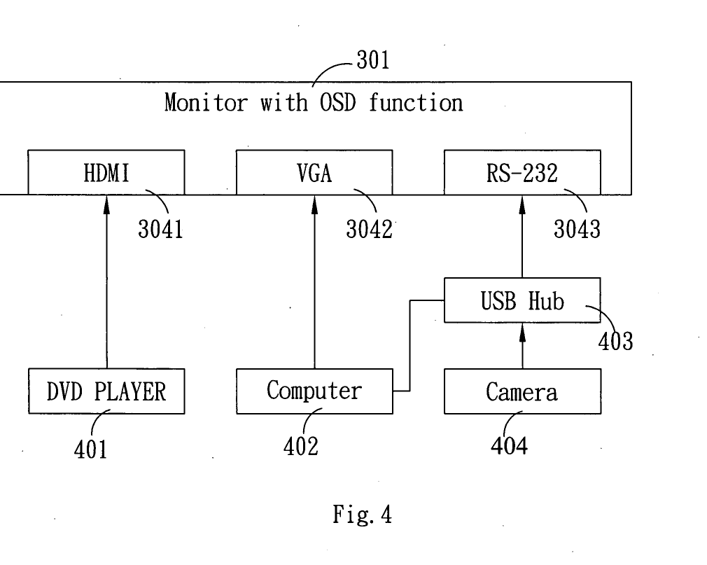

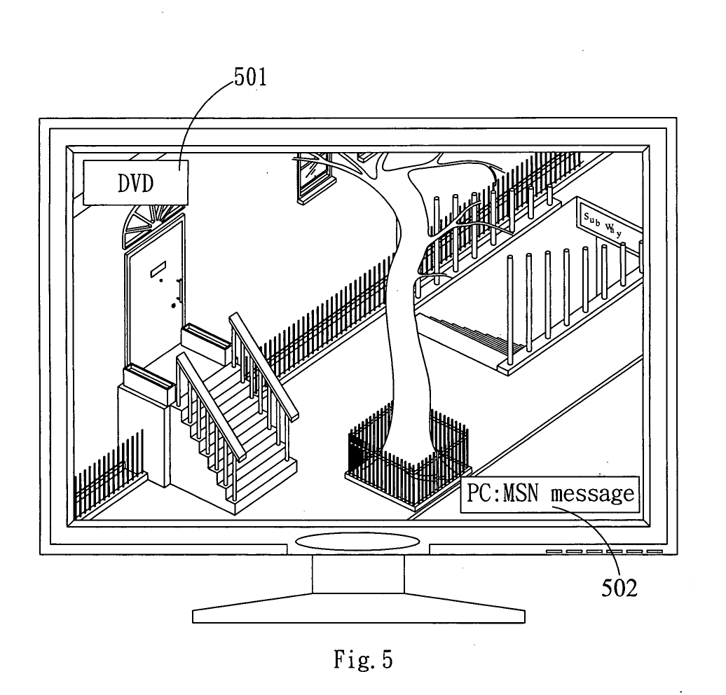

FIG. 4 illustrates the block diagram of system which describes more details of the preferred embodiment of the present invention. In this embodiment, the input units 304 of the monitor 301 with OSD function are connected to plural input interfaces to couple plural signal sources, for example, the HDMI interface 3041 for connecting the DVD Player, the VGA interface 3042 for connecting the computer, and the RS-232 interface 3043 connecting the USB HUB 403. Besides, the input unit can further connect to other interface, such as display port interface or DVI interface. There are two interfaces connected electricity between the monitor and computer, one is VGA input terminal 3042 for inputting image and sound signals, the other one is RS-232 interface 3043 connected to USB HUB 403 for inputting data signals. This system allows users to switch the signal source of the monitor from VGA interface 3042 to HDMI interface 3041 when users would rather watch images transmitted from DVD Player than keep monitoring the computer. Then, the microprocessor of monitor 301 will continue processing the image signal inputted via HDMI interface 3041, and omit the signals transmitted via VGA interface 3042 from the computer. At this time, the computer is kept operating, the microprocessor of the computer executes a routine programs to monitor the occurrence of the certain event in computer 402. The certain event can be reception of MSN messages, completion of downloading web pages, reception of new E-mail, or appearance of new dialog windows (ex: prompt windows for completion of downloading files or installing software). In this embodiment, when the microprocessor 303 (shown in FIG. 3) detect a event that the computer receives MSN messages, the microprocessor 303 generates an event code corresponding to the event, and the event code is then inputted to monitor 301 via USB HUB 403 and RS-232 interface 3043 shown in FIG. 4. After the microprocessor 303 (shown in FIG. 3) of the monitor receives the event code, the microprocessor 303 determines whether OSD should be enabled. If yes, the monitor not only display the DVD image 501, but the words “PC: MSN MESSAGE” 502 corresponding to the event message by OSD function, as shown in FIG. 5. Thus, users can monitor certain events occurred in plural signal sources simultaneously. Besides, the USB HUB 403 can be built in the monitor. At this time, if USB HUB 403 has 4 USB interfaces, one of these interfaces is connected to RS-232 interface and the others can be connected to exterior USB apparatus, ex: camera 404.

With the same theory, the user can use this method to monitor signal sources that is not the computer, such as DVD Player 401. When user selects to monitor the computer, his/her can also know the event occurred in the DVD Player simultaneously. When the DVD Player is set to prerecord a 30-minute-long program, the DVD Player will transmit event code to the monitor via HDMI interface after the preset time is up, and then the microprocessor of monitor will enable the OSD function to display a word similar to word 502 shown in FIG. 5 on the monitor after receiving event code.

With the same theory, in another embodiment of this present invention, there is only one signal source connected to one input interface, such as the VGA interface 3042 connected to the computer shown in FIG. 4. When the computer is operated in full-screen mode, we still can utilize the above-mentioned method to monitor the occurrence of new E-mails or MSN messages. When users select to watch files or films in full-screen mode, the computer monitors the occurrence of said certain event. When detecting that the certain event occurred, the computer will transmit an event code to the monitor in the same manner and the words as that shown in FIG. 5 will be generated.

In another embodiment, the event code is not transmitted to the monitor via RS-232 interface 3043 connected to USB HUB 403. In stead, the event code is transmitted via a pin of VGA interface 3042, and the pin is not defined function. When the microprocessor of the monitor receives the event code transmitted from the pin, the microprocessor follows the above-mentioned method to display the words corresponding to the event message on the monitor; In this embodiment, we can also use the pin of VGA interface 3042 which is use to transmit the resolution signal in the beginning. When the display resolution on the monitor is decided, the pin does not need to transmit resolution signal and can change to transmit the event code. The transmission via VGA interface is easily conjectured by those who are familiar with this art in this technical field, so we don't talk too much herein. The technique of transmitting signal via VGA interface is well-known, and for the sake of brevity, further discussion is omitted.

Besides, the method of generating event code corresponding to the event by the computer can be performed by the application program stored in the computer, or the operating system installed in the computer, or storing these event codes in the microprocessor of DVD player in advance so that the signal sources can generate event code actively when events occur.

Beside, the monitor of the present invention can further display the occurred event according to the inputted image signal, the inputted audio signal or the inputted TV signal. In one embodiment, the monitor can determine the occurrence of the certain event by detecting the known change in inputted signal. For example, most computer will output a preset prompt voice or pop a preset prompt window for remind the user when receiving a MSN message or a new E-mail, so the processor of the monitor can analyze the received image signal or the audio signal from the computer to determine whether the certain event occurs, such as receipt of MEN message or new E-mail. For example, if the processor detects that only right bottom corner area of the inputted image has change, it is possibly that a prompt MSN window is popped, and the processor can generate word corresponding to this event. For example, the processor detects the sudden change in inputted audio, and the audio change substantially matches the preset prompt voice, it is possibly that a MSN message or a new E-mail is received, so the processor can generate word corresponding to this event.

In one embodiment, the monitor can determine the occurrence of the certain event by detecting the strength of the inputted signal or the content of the inputted signal. A digital TV with TV record function is taken as an example. The digital TV can be connected with the cable line to receive the TV signal and record the TV program according to a preset schedule, and connected with a computer to receive a image signal. When the user starts the TV record function and switch to monitor the image of the computer, if the processor of the digital TV detects that the strength of the TV signal is lower than a threshold or no coming image signal, it mean the TV signal is too weak and the content is not clear, the processor can generate word corresponding to this event and display it by OSD function to remind the user, and so that the user can stop recording the program for saving space of the storage unit.

Besides, if the TV signal further contains a signal information of TV program guide and the digital TV allows the user to set favor programs, when the processor detects that the preset program is going to broadcast according to signal information of the TV program guide and the user is monitoring other signal source, the processor can generate word corresponding to this event and display it by OSD function to remind the user, so that the user can switch to TV source in time.

Besides, When the monitor is connected to the computer through display port interface, the processor of the monitor can receive the information related to the operation status of the computer, such as information of entering sleep mode, information of entering standby mode or information of low battery capacitance. When the processor detect such information, if the user is monitoring other signal source, the processor can generate word corresponding to this event and display it by OSD function to remind the user. Besides, the processor can further actively transmit the inquiry command to the computer for obtaining more detail information about operation status of the computer.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of displaying events on a monitor having an input unit and a microprocessor with OSD function, the method comprising the steps of:
using the microprocessor of the monitor to receive the event code;
using the microprocessor of the monitor to determine whether the event code is stored in a storage unit in advance; and
enabling OSD function and displaying the words corresponding to the event code on the monitor when the microprocessor of the monitor determines that the event code is stored in the storage unit in advance.

2. The method of claim 1, wherein the event code is generated by the processor of the monitor according the signal characteristic from a signal source.

3. The method of claim 2, wherein the signal characteristic is signal strength, signal information or image data.

4. The method of claim 1, wherein the event code is generated by an application program of the signal source which is used for monitoring a microprocessor of the signal source, and when the application program detects that microprocessor in the signal source processes a certain event, the application program generates the event code corresponding to the certain event.

5. The method of claim 1, wherein the event code is generated actively by a microprocessor of the signal source while the microprocessor of the signal source processes a certain event.

6. The method of claim 1, wherein the monitor is connected with more than two signal sources, and displays the image of the first signal source, and the microprocessor of the monitor can judge event code generated by other signal sources.

7. The method of claim 2, wherein the microprocessor of the monitor determines the event code only in full-screen mode when the monitor is connected to only one signal source.

8. A monitor capable of displaying an occurred event, comprising:
a display unit for receiving an image signal and an event code;
a storage unit for storing the event code and the words corresponding to the event code;
an OSD driving module for displaying the words on the monitor; and
a microprocessor for determining whether the event code is stored in the storage unit in advance, and driving the OSD driving module according to the determined result.

9. The monitor of claim 8, wherein the event code is generated by the microprocessor according the signal characteristic from a signal source.

10. The monitor of claim 9, wherein the signal characteristic is signal strength, signal information or image data.

11. The monitor of claim 8, wherein the received event code is generated by an application program in the signal source which is used for monitoring a microprocessor in the signal source, and when the application program detects that microprocessor of the signal source processes a certain event, the application program generates the event code corresponding to the certain event.

12. The monitor of claim 8, wherein the received event code is generated actively by a microprocessor of the signal source while the microprocessor of the signal source processes a certain event.

13. The monitor of claim 8, wherein the monitor displays the image of the first signal sources when the monitor is connected to more than two signal sources, and the microprocessor of the monitor can determine the event code generated by other signal source.

14. The monitor of claim 9, wherein the microprocessor of the monitor only determines the event code in full-screen mode when the monitor is connected with only one signal source.

15. A system of actively displaying certain event on the monitor, comprising:
at least one signal source capable of transmitting an image signal and an event code containing an event message; and
a monitor with OSD function, comprising:
at least one input interface for receiving the image signal and the event code; and
a microprocessor for determining the event code, and deciding whether to enabling the OSD function according to the determined result, and displaying the words corresponding to the event code on the monitor by OSD.

16. The system of claim 15, wherein the event code transmitted from the signal source is generated by an application program of the signal source which is used for monitoring a microprocessor in the signal source, and when the application program detects that microprocessor in the signal source processes a certain event, the application program generates the event code corresponding to the certain event.

17. The system of claim 15, wherein the event code transmitted from the signal source is generated actively by a microprocessor of the signal source while the microprocessor of the signal source processes a certain event.

18. The system of claim 15, wherein the event code is further generated by the microprocessor of the monitor according the signal characteristic from the signal source.

19. The system of claim 18, wherein the signal characteristic is signal strength, signal information or image data.

20. The system of claim 15, wherein the monitor displays the image of the first signal source when the system comprises more than two signal sources, and the microprocessor of the monitor can judge the event code generated by other signal source.

21. The system of claim 15, wherein the microprocessor of the monitor determines the event code only in full-screen mode when the system comprises only one signal source.
